(19) United States
(12) Patent Application Publication
(10) Pub. No.: US 2006/0209715 A1
(43) Pub. Date: Sep. 21, 2006

(54) Apparatus, system and method capable of node adaptive sleep scheduling in wireless adhoc networks

(76) Inventors: Nandakishore Kushalnagar, Portland, OR (US); Jasmeet Chhabra, Hillsboro, OR (US); Mark Yarvis, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/050,997

(22) Filed: Feb. 4, 2005

(51) Int. Cl. H04L 12/28; H04L 12/56

(52) U.S. Cl. 370/254; 370/400

(57) ABSTRACT

An embodiment of the present invention provides an apparatus, comprising a transceiver capable of dynamic cluster-based node sleep/wake scheduling by integrating application information such as scheduled data transfers with the sleep/wake scheduling, wherein the nodes may sleep immediately after a scheduled data transmission. Further, the nodes may intelligently and automatically choose to sleep based on the ongoing communication of its neighbors and the apparatus may be part of a wireless sensor network. The nodes may consist of battery-operated computing and sensing devices that collaborate to deliver sensed data and the delivery of the sensed data may be over multiple hops between multiple nodes.

### BACKGROUND

Wireless communications has become prevalent throughout society creating the need for faster, more reliable and less power consuming wireless communication techniques. Included in wireless networks are networks such as, but not limited to, sensor networks. In networks such as sensor networks, network lifetime may be problematic, particularly when nodes are battery powered. A wireless sensor network may consist of battery-operated computing and sensing devices (nodes) that collaborate to deliver sensed data, often over multiple hops.

Thus, a strong need exists for a system, apparatus and method capable of improved wireless network lifetime.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates cluster architecture in sensor networks.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follows may be presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause an effect relationship).

It should be understood that embodiments of the present invention may be used in a variety of applications. Although the present invention is not limited in this respect, the devices disclosed herein may be used in many apparatuses such as in the transmitters and receivers of a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDA's), wireless local area networks (WLAN), personal area networks (PAN, and the like) and sensor networks. Network lifetime is a key problem in battery-powered sensor networks. Since many sensor networks have long periods without data traffic, it may make sense for nodes to sleep periodically. For example and not by way of limitation, in a preventative-maintenance equipment monitoring application, the health of each piece of equipment may only need to be checked on a weekly basis.

Existing sleep wake protocols may tweak medium access control (MAC) protocols to achieve extended lifetime (such as SMAC, BMAC, etc), whereas an embodiment of the present invention may use application and routing information to determine when nodes could sleep and wakeup. The wake period of this invention may be adaptive with respect to the size of the cluster—for example, but not limited to, the nodes wake up only for the duration when nodes within the cluster send data. Further, the present invention is dynamic thereby enabling applications to be able to tweak parameters such as sleep duration, time to sleep, etc. at runtime.

An embodiment of the present invention proposes a method capable of scheduling the wake and sleep periods of battery-powered sensor nodes to maximize node utilization and minimize power consumption which may utilize a power saving protocol that divides the network into clusters, where the nodes in each cluster sleep and wake together. The present invention may integrate scheduled data transfers and application information with sleep/wake scheduling, thereby allowing nodes to sleep immediately after a scheduled data transmission. An embodiment of the present invention may also allow nodes to intelligently and automatically choose to sleep based on the ongoing communication of its neighbors without the need for any user intervention; although the present invention is not limited in this respect.

A wireless sensor network may consist of battery-operated computing and sensing devices (nodes) that collaborate to deliver sensed data, often over multiple hops. While network lifetime is a key concern in sensor networks, communication patterns are typically sparse, and nodes may spend much of their time sleeping to save energy. Without the ability for nodes to sleep, the need to change batteries would increase the cost of maintaining a sensor network. A protocol that allows nodes to sleep must wake neighbors together to communicate without increasing latency or requiring buffering to deliver bulk data across multiple hops. However, to minimize energy consumption, nodes should only be awake when transmitting/forwarding data, receiving data, capturing data, or computing data. In other words the idle time where a node is awake not communicating or computing must be minimal.

Present techniques provide the division of networks into clusters, each with a cluster head. The cluster head or in charge may impose a fixed duty cycle on the cluster, sending a periodic beacon while the cluster is awake to tell the nodes within the cluster when to start sleeping and how long to sleep. While the beacon typically specifies a fixed sleep/wake cycle, it may also be used to update the “wake time,” either lengthening or shortening a given wake period. This technique may require the system to predict the exact amount of time required to complete a data transfer, during which the cluster must stay awake. Also nodes that miss the beacon will remain awake. Finally, all nodes in the cluster must be awake when the cluster is awake, even if they are not generating or forwarding data.

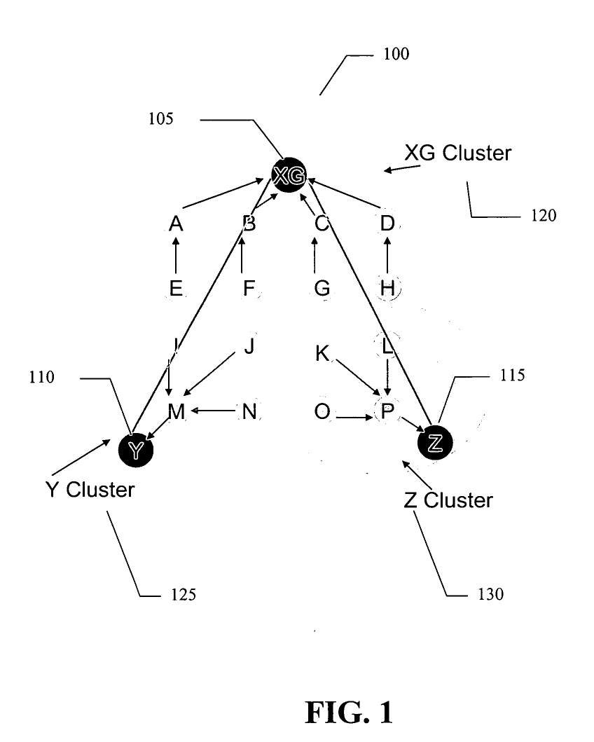

An embodiment of the present invention may use routing and application information to determine sleep wake schedules for nodes. Turning now to FIG. 1, shown generally as 100, is a typical sensor network. Nodes XG 120, Y 125 and Z 130 may be cluster head nodes. Apart from being a cluster head node, node XG 120 may also be a gateway to the application and thus act as a single sink for the network. Cluster heads 120, 125 and 130 may have a high-bandwidth and highly-reliable link to the gateway node. Both cluster head nodes 125 and 130 and the gateway node 120 may have, although are not required to have, an infinite source of power (e.g. wall power). The cluster head may use routing metrics to attract nearby nodes to route data through the cluster head, creating virtual multihop clusters of nodes. Nodes know which cluster they belong to from a tag in their selected route update packet. Unlike a simple protocol in which all nodes in the cluster are simultaneously awake, an embodiment of the present invention may use a sleep wake schedule that is tied to a schedule of data transfers. The following is an illustration of one embodiment of the invention, however, it is understood it is but one of many embodiments that are intended to be within the scope of the general principles articulated above.

Phase 1 may be the routing phase wherein when nodes wake up, they form routes to a destination. As shown in FIG. 1, the destination is to XG 120. Popular routing protocols such as Destination Sequenced Distance Vector (DSDV), Ad hoc On Demand Distance Vector (AODV) exist to create such routes. Nodes Y 125 and Z 130 have better connectivity to XG 120 and may have an infinite source of energy. These nodes advertise better routing metrics thus making them more attractive. Such nodes form cluster heads. The routing phase may go on through out the wake period so that nodes may change routes within the cluster during wake period.

Phase 2 may be the cluster head discovery phase. Within the routing information, cluster heads may also indicate the cluster head address. As the nodes in the network receive the routing information to the destination, they also identify the cluster they belong to (using phase 1). Once a node identifies its cluster, the node may ignore any message (including route update messages) that is not from its cluster. One way for a node to select a cluster head would be to use the first cluster head that a node receives a message from, although the present invention is not limited in this respect. This may be done in order to make sure that other cluster heads do not send messages that impact nodes within some other clusters. Like the routing phase, the discovery phase may also go on through out the wake period.

Phase 3 may be a node discovery phase. After the nodes identify their cluster heads, nodes within the cluster may identify themselves to the cluster head by sending trace route messages to the cluster head. The trace route messages may indicate the chosen cluster head. The chosen cluster head may wait for a certain period of time during which it may receive information about all nodes within the cluster. If a network comprises sensors as well as routers, nodes may choose to add this information as part of a piggyback within the trace route packet.

Phase 4 may be a data scheduling and transfer phase wherein the cluster head may initiate a data scheduling process and the cluster head may schedule data transfer from all nodes within its cluster. The data scheduling process may be accomplished in many distinct ways and the present invention is not limited to the exemplified methodologies articulated herein. One way of accomplishing data scheduling may be to use a round robin approach by the cluster head for scheduling data from all nodes within the cluster. The key information that the cluster head needs would be an indication from the network that the data transfer is completed.

As not all nodes in the cluster need to be powered on during data transfer from a subset of nodes, those nodes within the cluster that do not participate in the data routing process may turn themselves off for a short period of time and periodically wake up for a predefined duration to see if they are actively involved in data transmission. The choice of the value of may be application dependent.

Phase 5 may be the sleep phase wherein once the cluster head completes the data scheduling process of all nodes within the cluster, the cluster head sends a beacon indicating the sleep duration for the cluster and time until sleep. Sending the beacon at the end ensures that the node stays awake for just enough time for the data scheduling to finish. Furthermore it ensures that the all nodes are in sync with a single beacon instead of multiple beacon updates. The beacon may be sent multiple times with decreasing “time until sleep” to make sure that all nodes within the cluster receive them, although the present invention is not limited in this respect.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. An apparatus, comprising:
a transceiver capable of dynamic cluster-based node sleep/wake scheduling by integrating scheduled data transfers with said sleep/wake scheduling.

2. The apparatus of claim 1, wherein said nodes are allowed to sleep immediately after a scheduled data transmission.

3. The apparatus of claim 2, wherein said nodes are allowed to intelligently and automatically choose to sleep based on the ongoing communication of its neighbors.

4. The apparatus of claim 1, wherein said apparatus is part of a wireless sensor network and said nodes consist of battery-operated computing and sensing devices that collaborate to deliver sensed data.

5. The apparatus of claim 4, wherein said delivery of said sensed data is over multiple hops between multiple said nodes.

6. The apparatus of claim 1, wherein said dynamic cluster-based node sleep/wake scheduling by integrating scheduled data transfers with said sleep/wake scheduling is accomplished using route planning, cluster head discovery, node discovery, data scheduling, data transfer and sleeping.

7. The apparatus of claim 6, wherein said route planning includes when nodes wake up, forming routes to a destination and wherein superior nodes advertise better routing metrics and such nodes form cluster heads.

8. The apparatus of claim 7, wherein said route planning goes on throughout the wake period so that nodes can change routes within the cluster during wake period.

9. The apparatus of claim 6, wherein said cluster head discovery includes within the routing information cluster heads also indicating the cluster head address and as said nodes in said network receive the routing information to the destination, they also identify the cluster they belong in.

10. The apparatus of claim 6, wherein said cluster head discovery includes that once each node identifies its cluster, said node ignores any message, including route update messages, which are not from its cluster head and wherein the discovery phase can go on through out the wake period.

11. The apparatus of claim 6, wherein said data scheduling and data transfer includes a cluster head initiating a data scheduling process wherein said cluster head schedules data transfer from all nodes within its cluster.

12. The apparatus of claim 11, where said data scheduling comprises a round robin approach by said cluster head for scheduling data from all nodes within said cluster with an indication from the network that the data transfer is completed.

13. The apparatus of claim 11, wherein sleeping is initiated once said cluster head completes the data scheduling process of all nodes within the cluster by said cluster head sending a beacon indicating the sleep duration for the cluster and time until sleep.

14. The apparatus of claim 13, wherein said beacon is sent at the end, thereby ensuring that the node stays awake for just enough time for the data scheduling to finish.

15. The apparatus of claim 13, wherein said beacon is sent multiple times with decreasing time until sleeping to make sure that the beacon is sent multiple times for all nodes within the cluster to receive them.

16. A method of dynamic cluster-based, node sleep/wake scheduling, comprising:
integrating scheduled data transfers with said sleep/wake scheduling.

17. The method of claim 16, further comprising allowing said nodes to sleep immediately after a scheduled data transmission.

18. The method of claim 17, further comprising allowing said nodes to intelligently and automatically choose to sleep based on the ongoing communication of its neighbors.

19. The method of claim 16, further comprising adapting said apparatus to be part of a wireless sensor network and adapting said nodes to be battery-operated computing and sensing devices that collaborate to deliver sensed data.

20. The method of claim 19, further comprising delivering said sensed data over multiple hops between multiple said nodes.

21. The method of claim 16, further comprising scheduling said dynamic cluster-based node sleep/wake by integrating scheduled data transfers with said sleep/wake scheduling using route planning, cluster head discovery, node discovery, data scheduling and data transfer and sleeping.

22. The method of claim 21, further comprising deriving route planning by forming routes to a destination when nodes wake up and advertising better routing metrics.

23. The method of claim 22, further comprising planning said route to go on through out the wake period so that nodes can change routes within the cluster during wake period.

24. An article, comprising:
a storage medium having stored thereon instructions, that, when executed by a computing platform results in:
dynamic cluster-based node sleep/wake scheduling by integrating scheduled data transfers with said sleep/wake scheduling.

25. The article of claim 24, further comprising allowing said nodes to sleep immediately after a scheduled data transmission.

26. The article of claim 24, further comprising allowing said nodes to intelligently and automatically choose to sleep based on the ongoing communication of its neighbors.

27. The article of claim 24, further comprising adapting said apparatus to be part of a wireless sensor network wherein said nodes are battery-operated computing and sensing devices that collaborate to deliver sensed data.
